(19) United States
(12) Patent Application Publication
(10) Pub. No.: US 2021/0409900 A1
(43) Pub. Date: Dec. 30, 2021

(54) Dynamic Capability Reporting Based on Position

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/289,685

(22) PCT Filed: Nov. 15, 2019
(86) PCT No.: PCT/US2019/061724

§ 371 Date: Apr. 28, 2021

Related U.S. Application Data
(60) Provisional application No. 62/775,349, filed on Dec. 4, 2018.

(51) Int. Cl. H04W 4/02; H04W 4/029; H04W 48/14; H04W 52/02; H04W 48/16; H04W 76/18

(52) U.S. Cl. CPC H04W 4/025; H04W 4/029; H04W 48/14; H04W 76/18; H04W 52/0229; H04W 52/0274; H04W 48/16; H04W 52/0216

(57) ABSTRACT

This document describes techniques and devices for dynamic capability reporting based on position. A user equipment (UE) determines its current radio capability responsive to detecting a change in its position. If the current radio capability at a current position differs from a previous radio capability at a previous position, the UE modifies its radio capability based on the current position and informs a wireless communication network of the modification. The UE can inform the wireless communication network of this radio capability change using a tracking area update (TAU) message, a radio-link failure message, a reconfiguration failure message, or an attach-procedure message. The dynamic capability reporting enables the UE to change its radio capability as it moves to different positions that have different levels of network coverage within a same tracking area (TA) or a same radio access network (RAN) notification area.

### BACKGROUND

Within a tracking area (TA) or a radio access network (RAN) notification area of a wireless communication network, a user equipment (UE) moves between locations that have different levels of network coverage (e.g., cell coverage or mobile network coverage). At these different locations, the UE performs a measurement procedure to determine whether network coverage is available. If the UE is at a location that does not have network coverage, current techniques may cause the UE to perform the measurement procedure multiple times. Some UEs are mobile devices that have a limited amount of available power. Consequently, these multiple measurement procedures can quickly drain a UE's battery.

### SUMMARY

Techniques and apparatuses are described for dynamic capability reporting based on position. In particular, a user equipment (UE) determines its current radio capability responsive to detecting a change in its position, which can be a change to the UE's physical location, a change to the UE's orientation, or a combination thereof. If the current radio capability at a current position differs from a previous radio capability at a previous position or orientation, the UE modifies its radio capability based on the current position and informs a wireless communication network of the modification. The UE can inform the wireless communication network of this radio capability change using a tracking area update (TAU) message, a radio-link failure message, a reconfiguration failure message, or an attach-procedure message. The dynamic capability reporting enables the UE to change its radio capability as it moves to different positions that have different levels of network coverage within a same tracking area (TA) or a same radio access network (RAN) notification area.

The UE also manages its resources based on its current radio capability. By modifying the radio capability to indicate that the UE does not have network coverage for a particular radio access technology (RAT) at a given frequency band at the current position, the UE conserves power by not performing additional measurement procedures that otherwise can occur if the radio capability incorrectly indicates that the UE has network coverage at the current position. Additionally, the UE disables operations or components within a wireless transceiver while the UE is at the current position to further conserve power. If the UE moves to a different position that has network coverage for the particular RAT and the frequency band, the UE assigns resources so that the UE can use the RAT and/or the frequency band to improve wireless communication performance.

The UE provides feedback to a coverage map manager of the wireless communication network using a position-specific capability feedback message. The position-specific capability feedback message informs the coverage map manager of the UE's position and the UE's radio capability at this position. The coverage map manager generates and maintains a coverage map based on position-specific capability feedback messages received from the UE and other UEs. With this information, the coverage map manager builds a multi-dimensional map showing positions that are likely or unlikely to have network coverage for a particular RAT and frequency band. By using the UEs to report their radio capabilities and positions, the network coverage can be determined for a variety of different types of positions, including positions that are physically located inside buildings, along pedestrian walkways or hiking routes, or at various altitudes either indoors or outdoors. Furthermore, the coverage map manager continually updates the coverage map to accurately represent current network coverage, which can change based on changes in the environment. The UE receives the coverage data from the coverage map manager and uses the coverage data to determine radio capabilities at different positions in addition to or instead of performing the measurement procedure.

Aspects described below include a method of a user equipment for dynamic capability reporting based on position. The method includes the user equipment operating with a first radio capability at a first position. The method also includes detecting a first change in a measured position of the user equipment from the first position to a second position. The method additionally includes receiving a coverage map message from a coverage map manager of a wireless communication network. The coverage map message includes coverage data associated with the second position. The coverage data indicates a likelihood of network coverage at the second position. The method further includes determining a second radio capability of the user equipment based on the coverage data. Responsive to the second radio capability being different than the first radio capability, the method includes informing the wireless communication network of the second radio capability.

The first radio capability may indicate that the user equipment has network coverage for a first frequency band at the first position. The second radio capability may indicate that the user equipment does not have network coverage for the first frequency band at the second position.

Informing the wireless communication network may comprise informing the wireless communication network of the second radio capability using a second frequency band.

The first frequency band may be associated with a first radio access technology (RAT). The second frequency band may be associated with a second radio access technology.

The first frequency band may include frequencies greater than approximately 24 gigahertz (GHz). The second frequency band may include frequencies less than approximately 24 gigahertz.

The coverage map message may include coverage data associated with a third position. The coverage data may indicate a likelihood of network coverage at the third position. The method may further comprise detecting a second change in the measured position of the user equipment from the second position to the third position. The method may further comprise determining a third radio capability of the user equipment based on the coverage data. The method may further comprise informing the wireless communication network of the third radio capability responsive to the third radio capability being different than the second radio capability.

The third radio capability may indicate that the user equipment has network coverage for a third frequency band at the third position.

Informing the wireless communication network may comprise sending a tracking area update message to the wireless communication network.

The tracking area update message may include information that indicates whether or not the UE has radio capability for a particular RAT. The tracking area update message may optionally indicate one or more frequency bands as a radio capability parameter. The wireless communication network may use this information to determine the current radio capability of the UE. In this way, the tracking area update message can be used to effectively indicate whether the UE has network coverage or does not have network coverage at a given position.

Advantageously, multiple tracking area update messages are sent as the UE determines that the network coverage changes as it moves to different positions (e.g., locations and/or orientations) within a same TA. This is in contrast to previous triggers that may only send a tracking area update message if a TA of the UE changes, for instance. This may lead to the wireless communication network having more up-to-date network coverage information for the UE.

Informing the wireless communication network may comprise triggering a radio-link failure procedure. Informing the wireless communication network may comprise sending a radio-link failure message to the wireless communication network as part of the radio-link failure procedure.

Informing the wireless communication network may comprise triggering a reconfiguration failure procedure. Informing the wireless communication network may comprise sending a reconfiguration failure message to the wireless communication network as part of the reconfiguration failure procedure.

A radio-link failure procedure can cause the UE to send a radio-link failure message and/or a reconfiguration failure message. This may direct the wireless communication network to delete or otherwise modify stored radio capability information of the UE, which may include the previous radio capability. This may indirectly inform the wireless communication network of the UE's current radio capability and may indicate that the UE does not have network coverage at the current position.

Informing the wireless communication network may comprise sending an attach-procedure message to the wireless communication network during an attach procedure.

Similar to the tracking area update message, the attach-procedure message may include radio capability information to directly inform the wireless communication network of the current radio capability of the UE.

The first change in the measured position may comprise a translation in space from the first position to the second position. The first position and the second position may be within a same tracking area or Radio Access Network notification area of the wireless communication network.

The first change in the measured position may further comprises a rotation in space from the first position to the second position.

The method may further comprise determining that the first position and the second position each correspond to: a first location that is inside a building; a second location that is outside; or a third location that is inside a tunnel.

Aspects described below include a user equipment with a radio-frequency transceiver. The user equipment also includes a processor and memory system configured to perform any of the methods described.

Aspects described below also include a system with means for dynamic capability reporting based on position.

### BRIEF DESCRIPTION OF THE DRAWINGS

Apparatuses of and techniques for dynamic capability reporting based on position. The same numbers are used throughout the drawings to reference like features and components:

FIG. 1 illustrates an example wireless network environment in which dynamic capability reporting based on position can be implemented.

FIG. 2 illustrates an example device diagram of a user equipment and a base station for dynamic capability reporting based on position.

FIG. 3 illustrates a variety of different positions and changes in an environment for which network coverage varies.

FIG. 4 illustrates details of example operations of a user equipment engaged in dynamic capability reporting based on position.

FIG. 5 illustrates details of example data and control transactions between devices for dynamic capability reporting based on position.

FIG. 6 illustrates an example sequence flow diagram for managing system resources according to a map-based radio capability.

FIG. 7 illustrates an example method for dynamic capability reporting based on position.

### DETAILED DESCRIPTION

Overview

This document describes techniques and devices for dynamic capability reporting based on position. Current techniques may cause a user equipment (UE) to perform a measurement procedure multiple times while the UE is at a location that does not have network coverage at a particular frequency band or using a given radio access technology (RAT). Some UEs are mobile devices that have a limited amount of available power. Consequently, these multiple measurement procedures can quickly drain a UE's battery.

In contrast, techniques for dynamic capability reporting based on position are described herein. In particular, a UE determines its current radio capability responsive to detecting a change in its position, which can be a change to the UE's physical location, a change to the UE's orientation, or a combination thereof. If the current radio capability at a current position differs from a previous radio capability at a previous position, the UE modifies its radio capability based on the current position and informs a wireless communication network of the modification. The UE can inform the wireless communication network of this radio capability change using a tracking area update (TAU) message, a radio-link failure message, a reconfiguration failure message, or an attach-procedure message. The dynamic capability reporting enables the UE to change its radio capability as it moves to different positions that have different levels of network coverage within a same tracking area (TA) or a same radio access network (RAN) notification area.

The UE also manages its resources based on its current radio capability. By modifying the radio capability to indicate that the UE does not have millimeter-wave (mmWave) network coverage at the current position, for instance, the UE conserves power by not performing additional mmWave measurement procedures that otherwise can occur if the radio capability incorrectly indicates that the UE has mmWave network coverage at the current position. Additionally, the UE disables mmWave operations or components within a wireless transceiver while the UE is at the current position to further conserve power. If the UE moves to a different position that has network coverage for a particular RAT at a given frequency band, the UE assigns resources so that the UE can use the RAT and/or frequency band to improve wireless communication performance.

The UE provides feedback to a coverage map manager of the wireless communication network using a position-specific capability feedback message. The position-specific capability feedback message informs the coverage map manager of the UE's position and the UE's radio capability at this position. The coverage map manager generates and maintains a coverage map based on position-specific capability feedback messages received from the UE and other UEs. With this information, the coverage map manager builds a multi-dimensional map showing positions that are likely or unlikely to have network coverage for a particular RAT and frequency band. By using the UEs to report their radio capabilities and positions, the network coverage can be determined for a variety of different types of positions, including positions that are physically located inside buildings, along pedestrian walkways or hiking routes, or at various altitudes. Furthermore, the coverage map manager continually updates the coverage map to accurately represent current network coverage, which can change based on changes in the environment. The UE receives the coverage data from the coverage map manager and uses the coverage data to determine radio capabilities at different positions in addition to or instead of performing the measurement procedure.

Example Environment

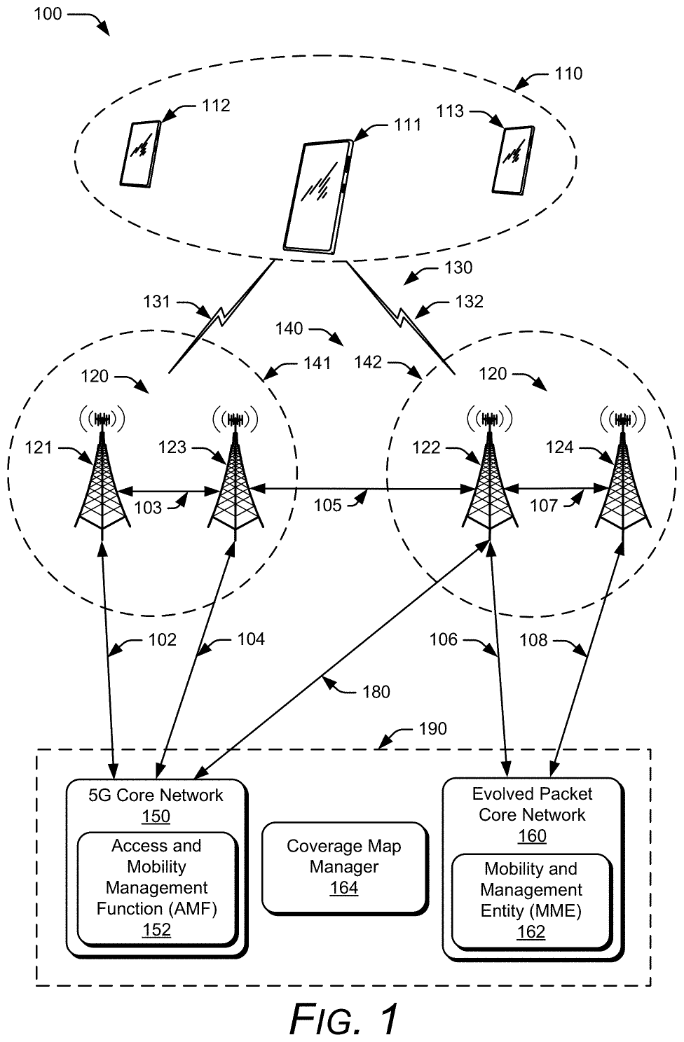

FIG. 1 illustrates an example environment 100, which includes multiple user equipment 110 (UE 110), illustrated as UE 111, UE 112, and UE 113. Each UE 110 can communicate with base stations 120 (illustrated as base stations 121, 122, 123, and 124) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Evolved Node B, ng-eNB, Next Generation Node B, gNode B, gNB, or the like) are implemented in a macrocell, microcell, small cell, picocell, or the like, or any combination thereof.

The base stations 120 communicate with the UE 110 using the wireless links 131 and 132, which is implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 include one or more wireless links (e.g., radio links) or bearers implemented using any suitable communication protocol or standard, or combination of communication protocols or standards such as 3rd Generation Partnership Project Long-Term Evolution (3GPP LTE), Enhanced Long-Term Evolution (eLTE), Fifth-Generation New Radio (5G NR), Fourth-Generation (4G) standard, Third-Generation (3G) standard, and so forth. Multiple wireless links 130 can be aggregated in a carrier aggregation to provide a higher data rate for the UE 110. Multiple wireless links 130 from multiple base stations 120 can be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, or NR RAN). The RANs 140 are illustrated as an NR RAN 141 and an E-UTRAN 142. In FIG. 1, core networks 190 are shown to include a Fifth-Generation Core (5GC) network 150 (5GC 150) and an Evolved Packet Core (EPC) network 160 (EPC 160), which are different types of core networks. The base stations 121 and 123 in the NR RAN 141 are connected to the 5GC 150. The base stations 122 and 124 in the E-UTRAN 142 are connected to the EPC 160. Optionally or additionally, the base station 122 connects to both the 5GC 150 and EPC 160 networks.

The base stations 121 and 123 connect, at 102 and 104 respectively, to the 5GC 150 through an NG2 interface for control-plane signaling and using an NG3 interface for user-plane data communications. The base stations 122 and 124 connect, at 106 and 108 respectively, to the EPC 160 using an Si interface for control-plane signaling and user-plane data communications. Optionally or additionally, if the base station 122 connects to the 5GC 150 and EPC 160 networks, the base station 122 connects to the 5GC 150 using the NG2 interface for control-plane signaling and through the NG3 interface for user-plane data communications, at 180.

In addition to connections to core networks 190, the base stations 120 communicate with each other. For example, the base stations 121 and 123 communicate through an Xn interface at 103, the base stations 122 and 123 communicate through an Xn interface at 105, and the base stations 122 and 124 communicate through an X2 interface at 107.

The 5GC 150 includes an Access and Mobility Management Function 152 (AMF 152), which provides control-plane functions, such as registration and authentication of multiple UE 110, authorization, and mobility management in the 5G NR network. The EPC 160 includes a Mobility Management Entity 162 (MME 162), which provides control-plane functions, such as registration and authentication of multiple UE 110, authorization, or mobility management in the E-UTRA network. The AMF 152 and the MME 162 communicate with the base stations 120 in the RANs 140 and also communicate with multiple UE 110, using the base stations 120.

One or more of the core networks 190 include a coverage map manager 164, which can be integrated as part of the core network 190 (e.g., as part of the 5GC 150 or the EPC 160) or can be implemented within a server of the core network 190, such as a cloud server. The coverage map manager 164 stores and maintains at least one coverage map. In general, the coverage map is a multi-dimensional map or table that includes coverage data, which indicates a likelihood that coverage exists at different positions. These different positions can include different physical locations and/or different orientations. The coverage map is also associated with a particular RAT, such as a 5G RAT, a WiMAX™ RAT, a 4G RAT, a WiFi™ RAT, a 3G RAT, and so forth, and may also specify particular licensed or unlicensed frequency bands for each RAT. In some cases, the coverage map or the coverage data within the coverage map is associated with a frequency number, a bandwidth, or base station physical cell identity (PCI) information.

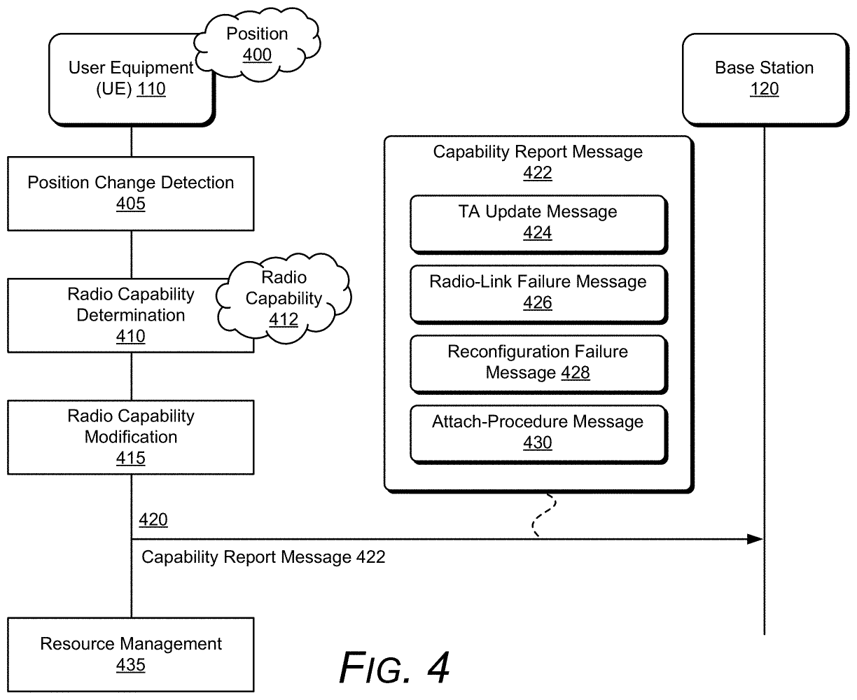

Changes in a surrounding environment can affect some types of RATs or frequency bands more than others. For example, a 5G RAT can use mmWave wireless communication signals with frequencies that include those at or near the extremely-high frequency (EHF) spectrum (e.g., frequencies greater than approximately 24 gigahertz (GHz)) and wavelengths at or near millimeter wavelengths (mmW). These mmWave wireless communication signals can experience higher losses or attenuation (e.g., path loss, atmospheric loss, or attenuation through rain) relative to other wireless communication signals that utilize lower frequencies and larger wavelengths, such as those used for earlier generation protocols (e.g., 4G or 3G signals) or other 5G signals that operate at sub-6 GHz frequencies. As such, network coverage for different RATs and different frequency bands can vary, and the coverage map manager 164 can store and maintain multiple coverage maps for respective RATs operating on different frequency bands. The coverage map manager 164 is further described with respect to FIG. 4.

Example Devices

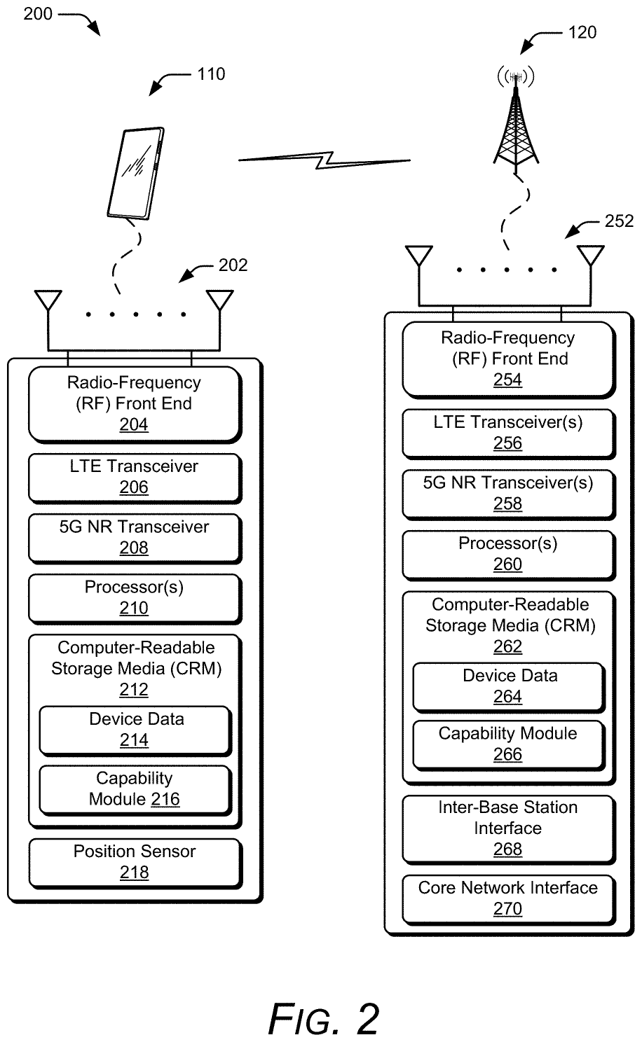

FIG. 2 illustrates an example device diagram 200 of the UE 110 and the base station 120. The UE 110 and the base station 120 include additional functions and interfaces that are omitted from FIG. 2 for the sake of clarity. The UE 110 includes antennas 202, a radio-frequency (RF) front end 204 (RF front end 204), an LTE transceiver 206, and a 5G NR transceiver 208 for communicating with base stations 120 in the 5G RAN 141 and/or the E-UTRAN 142. The RF front end 204 of the UE 110 couple or connect the LTE transceiver 206 and the 5G NR transceiver 208 to the antennas 202 to facilitate various types of wireless communication. The antennas 202 of the UE 110 include an array of multiple antennas that are configured similar to or different from each other. The antennas 202 and the RF front end 204 can be tuned to, and/or be tunable to, one or more licensed or unlicensed frequency bands defined by the IEEE, 3GPP LTE, and 5G NR communication standards and implemented by the LTE transceiver 206, the 5G NR transceiver 208, and/or other transceivers (not shown). By way of example and not limitation, the antennas 202 and the RF front end 204 can be implemented for operation in sub-gigahertz bands, sub-6 GHz bands, and/or bands with frequencies between approximately 5 and 300 GHz that are defined by the 3GPP LTE and 5G NR communication standards. In some cases, the antennas 202 and the RF front end 204 can be implemented for operation in the extremely-high frequency spectrum (e.g., for frequencies that are between approximately 24 and 300 GHz).

The UE 110 also includes processor(s) 210 and computer-readable storage media 212 (CRM 212). The processor 210 can be a single-core processor or a multi-core processor composed of a variety of materials, such as silicon, polysilicon, high-K dielectric, copper, and so on. The computer-readable storage media described herein excludes propagating signals. CRM 212 includes any suitable memory or storage device such as random-access memory (RAM), static RAM (SRAM), dynamic RAM (DRAM), non-volatile RAM (NVRAM), read-only memory (ROM), or Flash memory useable to store device data 214 of the UE 110. The device data 214 includes user data, multimedia data, beamforming codebooks, applications, and/or an operating system of the UE 110, which are executable by processor(s) 210 to enable user-plane communication, control-plane signaling, and user interaction with the UE 110.

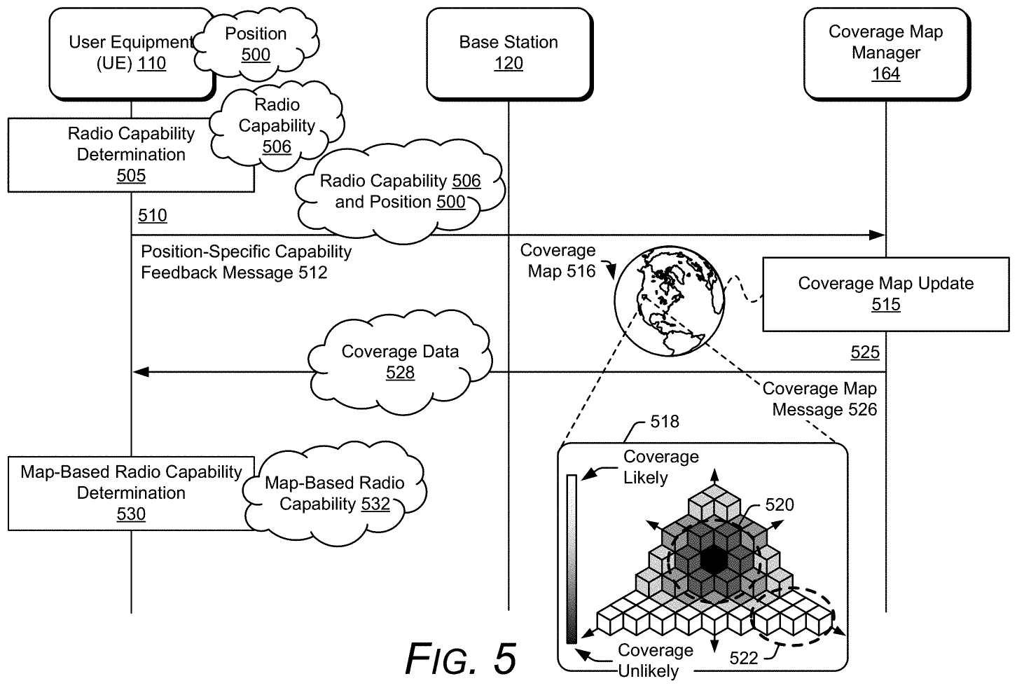

CRM 212 also includes a capability module 216. Alternatively or additionally, the capability module 216 is implemented in whole or part as hardware logic or circuitry integrated with or separate from other components of the UE 110. In at least some aspects, the capability module 216 configures the LTE transceiver 206 or the 5G NR transceiver 208 for communication with the base station 120. In this way, the capability module 216 uses a transceiver of the UE 110 to inform the wireless communication network of a change to its radio capability or to provide feedback to the coverage map manager 164, as further described with respect to FIGS. 4 and 5.

The capability module 216 determines a current radio capability of the UE 110 for a current position. Generally, radio capability indicates whether or not the UE 110 can successfully communicate with the RAN 140 using a particular RAT, which may be specific to a given frequency band. The radio capability can be independently determined based on RAT measurements (e.g., signal strength measurements or received signal strength indicators (RSSI)), based on coverage data provided by the coverage map manager 164, or a combination thereof.

The capability module 216 also adjusts wireless communication operations of the UE 110 based on the determined radio capability. For example, the capability module 216 disables operations or components (e.g., disrupts a supply of power to components) within a transceiver while the UE 110 is at a position that does not have network coverage. In this manner, the capability module 216 can conserve system resources of the UE 110 if the UE 110 does not have radio capability at the current position. If the UE 110 does not have network coverage for the 5G RAT at mmWave frequency bands and disables operations of the 5G NR transceiver 208 that are associated with the mmWave frequency bands, the UE 110 can continue to communicate with the wireless communication network using other frequency bands and the LTE transceiver 206 and/or the 5G NR transceiver 208.

The capability module 216 is coupled to a position sensor 218 of the UE 110 and obtains position information from the position sensor 218. The position information includes at least a multi-dimensional position of the UE 110, which can include a latitude, a longitude, and/or an altitude and optionally a pitch, roll, and/or yaw of the UE 110 in space. Generally, the multi-dimensional position is an absolute position of the UE 110 according to a particular coordinate system, such as a geographic or projected coordinate system. In other implementations, the multi-dimensional position is a relative position according to a particular position whose coordinates are known. An accuracy of the multi-dimensional position can be on the order of a few meters (e.g., within approximately 1 meter or less than approximately 20 meters). In general, the multi-dimensional position has a higher resolution than a TA or a RAN notification area associated with the current position of the UE 110. The position information can also include other information about the surrounding environment as further described below. In some aspects, the capability module 216 uses the position information to gather additional information about the current position, such as weather data from an application of the UE 110. The capability module 216 communicates the position information or the radio capability to the wireless communication network, as further described with respect to FIGS. 4 and 5.

The position sensor 218 measures a position of the UE 110 and can include a global navigation satellite system (GNSS) sensor or a global positioning system (GPS) sensor. The position sensor 218 can also include or be coupled to additional sensors, such as an accelerometer, a gyroscope, a magnetometer, an inertial sensor, a radar sensor, and the like. With one or more of these additional sensors, the position sensor 218 can use techniques, such as dead reckoning, to improve position accuracy. The position sensor 218 can also be coupled to other types of sensors that determine characteristics of the surrounding environment or detect changes in a position of the UE 110. These other types of sensors can include an image processing sensor, a camera sensor, the radar sensor, a temperature sensor, or other wireless receivers such as a WiFi™ transceiver that receives WiFi™ broadcast signals or a Bluetooth™ transceiver that receives Bluetooth™ position beacons. As an example, the position sensor 218 determines whether the UE 110 is indoors or outdoors based on data provided by one or more of these sensors.

The device diagram for the base station 120, shown in FIG. 2, includes a single network node (e.g., a gNode B). The functionality of the base station 120 can be distributed across multiple network nodes or devices and can be distributed in any fashion suitable to perform the functions described herein. The base station 120 includes antennas 252, a radio-frequency (RF) front end 254 (RF front end 254), one or more LTE transceivers 256, and/or one or more 5G NR transceivers 258 for communicating with the UE 110. The RF front end 254 of the base station 120 couple or connect the LTE transceivers 256 and the 5G NR transceivers 258 to the antennas 252 to facilitate various types of wireless communication. The antennas 252 of the base station 120 include an array of multiple antennas that are configured similar to or different from each other. The antennas 252 and the RF front end 254 are tuned to, and/or are tunable to, one or more frequency bands defined by the 3GPP LTE and 5G NR communication standards, and implemented by the LTE transceivers 256 and/or the 5G NR transceivers 258. Additionally, the antennas 252, the RF front end 254, the LTE transceivers 256, and/or the 5G NR transceivers 258 are configured to support beamforming, such as Massive-MIMO, for the transmission and reception of communications with the UE 110.

The base station 120 also includes processor(s) 260 and computer-readable storage media 262 (CRM 262). The processor 260 can be a single-core processor or a multi-core processor composed of a variety of materials, such as silicon, polysilicon, high-K dielectric, copper, and so on. CRM 262 includes any suitable memory or storage device such as random-access memory (RAM), static RAM (SRAM), dynamic RAM (DRAM), non-volatile RAM (NVRAM), read-only memory (ROM), or Flash memory useable to store device data 264 of the base station 120. The device data 264 includes network scheduling data, radio resource management data, beamforming codebooks, applications, and/or an operating system of the base station 120, which are executable by the processor 260 to enable communication with the UE 110.

CRM 262 also includes a capability module 266. Alternatively or additionally, the capability module 266 is implemented in whole or part as hardware logic or circuitry integrated with or separate from other components of the base station 120. The capability module 266 configures the LTE transceivers 256 and the 5G NR transceivers 258 for communication with the UE 110.

The base station 120 includes an inter-base station interface 268, such as an Xn and/or X2 interface, which a base station manager (not shown) configures to exchange user-plane and control-plane data with another base station 120. The base station 120 also includes a core network interface 270 to exchange information with core network functions and entities, such as the coverage map manager 164. In this manner, the capability module 266 passes information between the coverage map manager 164 and the UE 110. The coverage map manager 164 of the core network 190, the capability module 216 of the UE 110, and the capability module 266 of the base station 120 can at least partially implement dynamic capability reporting based on position as described herein.

Dynamic Capability Reporting Based on Position

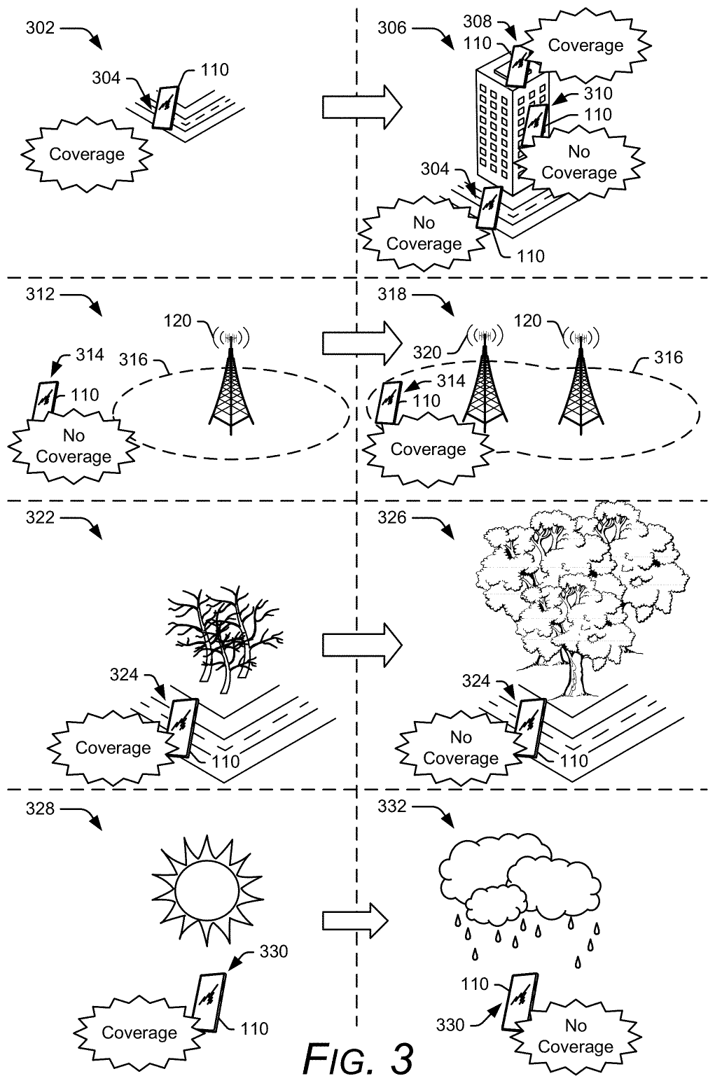

FIG. 3 illustrates a variety of different positions and changes in an environment for which network coverage varies. As the UE 110 moves within a given TA or a given RAN notification area, the UE 110 can move to a first position with network coverage using a variety of RATs and frequency bands or to a second position without network coverage using a particular RAT or frequency band. For example, network coverage for the 5G RAT using sub-6 GHz frequencies exists at a location and does not exist for the 5G RAT using frequencies higher than sub-6 GHz (e.g., mmWave frequencies) at the same location. As another example, network coverage using a 5G RAT at licensed frequency bands exists at another location and does not exist for the 5G RAT using unlicensed frequency bands at the same location. Sometimes one or more changes in the environment cause the network coverage at the first position or the second position to vary over time for one or more RATs or frequency bands.

At 302, a UE 110 is at an outdoor location 304 on a street corner, which can be near a parking lot, an undeveloped lot, or an open section of land. In this case, network coverage exists at the location 304, and the UE 110 has radio capability for a particular RAT, or several RATs, at a wide range of frequencies. At 306, however, a new building is built near the location 304. This building effectively blocks some of the wireless communication signals associated with a RAT and causes network coverage loss at the location 304. As such, the UE 110 no longer has radio capability at the location 304 and is unable to communicate with the RAN 140 using the affected RAT at specific frequency bands.

If the UE 110 moves to different locations within the building, the radio capability of the UE 110 changes. For example, if the UE 110 moves to a location that has network coverage, such as a roof of the building at location 308, a location near an exterior wall or window, or a location on a balcony, the UE 110 has radio capability for the RAT. However, if the UE 110 moves to an interior location 310 that does not have network coverage within the building, the UE 110 does not have radio capability for the RAT. Although the building can be considered to be within a TA or a RAN notification area, different locations or micro-environments within these areas may have different levels of network coverage based on differences in signal losses or attenuation that occur at these different locations. While network coverage may not be available in some locations using the particular RAT at a given frequency band, sometimes network coverage may still be available at these locations using a different RAT or another frequency band.

At 312, the UE 110 is at a location 314, which does not have network coverage for the particular RAT or frequency band due to a distance between the location 314 and a nearest base station 120. The network coverage provided by the base station 120 is represented by ellipse 316 for simplicity. The location 314 can be in a rural area outside city limits, or the effective network coverage provided by the base station 120 can be reduced by an obstacle, such as the building shown at 306. Over time, however, additional base stations are built to increase the effective network coverage. At 318, a distance between the location 314 and the additional base station 320 enables the location 314 to have network coverage for the particular RAT or frequency band, as indicated by the UE 110 being within the network coverage represented by 316.

At 322, the UE 110 is at a location 324, which is near a grove of trees. During a fall or winter season, the trees are bare or reduced in size due to manual trimming or loss of branches from windstorms. As the season changes to spring or summer, however, the trees can grow and have foliage. At 326, the foliage and larger size of the trees attenuates wireless communication signals more than the barren trees at 322. In this example, the increased attenuation causes the location 324 to have reduced or impaired network coverage for the RAT or frequency band during the spring or summer. In this manner, network coverage can improve or degrade as the surrounding plant life changes with the seasons.

At 328, the UE 110 is at a location 330 during a time that the weather is sunny. In this case, the location 330 has network coverage at a large range of frequency bands. At 332, however, the weather changes and rain occurs at the location 330. The rain attenuates certain wireless communication signals, such as mmWave signals, more than others and causes the location 330 to not have network coverage at the mmWave band. As such, the network coverage at the location 330 varies according to the weather.

As shown in the above examples, changes resulting from construction of new buildings or cell towers, surrounding vegetation, seasons, or weather patterns can cause the network coverage to vary over time. Other changes not described, such as natural disasters that reshape a landscape or destroy base stations, can also cause the network coverage to vary for one or more RATs or one or more frequency bands.

Network coverage can also vary for different orientations of the UE 110 (not shown). While at a same physical location, a first orientation of the UE 110 enables the UE 110 to have radio capability for a particular RAT or frequency band, and a second orientation causes the UE 110 to not have radio capability for the RAT or frequency band. For different pitches, rolls, or yaws of the UE 110, an orientation of the antennas 202 relative to the base station 120 changes, which can affect a polarization orientation of the antennas 202 or propagation paths over which signals travel between the antennas 202 and the base station 120. In other words, different orientations cause the UE 110 to experience different amounts of attenuation based on polarization mismatch losses or propagation losses in free space. In some cases, different antennas 202 associated with different frequency bands or different transceivers are at different locations within the UE 110. Therefore network coverage can further vary based on orientation for different RATs or different frequency bands. Additionally, different orientations increase or decrease a probability of a user's hand obstructing signals that are transmitted or received using the antennas 202.

The techniques for dynamic capability reporting based on position can provide an accurate coverage map that dynamically changes to represent the current network coverage. As the UEs 110 move to different positions, the determined radio capabilities and positions of the UEs 110 are fed back to the coverage map manager 164, as further described with respect to FIG. 5. Furthermore, the UEs 110 modify their radio capability based on the different positions, as further described with respect to FIG. 4.

FIG. 4 illustrates details of example operations of a UE engaged in dynamic capability reporting based on position. In this example, the UE 110 is at a current position 400. Prior to the current position 400, the UE 110 was at a previous position (not shown). The position sensor 218 determines a measured position of the UE 110 at both the current position 400 and the previous position. At the previous position, the UE 110 has a previous radio capability.

At 405, the capability module 216 of the UE 110 detects a change in the UE 110's position from the previous position to the current position 400. In some cases, the capability module 216 makes this determination based on the UE 110 moving a predetermined distance or angle relative to the previous position. Generally, the change in the UE 110's position can be a translation in space from a first location to a second location, a rotation in space from a first orientation to a second orientation, or a combination thereof. The capability module 216 makes this determination based on measurements provided by the position sensor 218 and/or other sensors within the UE 110, as described above with respect to FIG. 2.

At 410, the capability module 216 determines a current radio capability 412 of the UE 110 at the current position 400 responsive to detecting the change in the UE 110's position. In some cases, the capability module 216 independently determines the current radio capability 412 by performing a measurement procedure that measures a strength of received wireless communication signals associated with one or more RATs and one or more frequency bands supported by the UE 110. If the signal strength (e.g., signal-to-noise ratio (SNR) or received signal strength indication (RSSI)) is low or if the UE 110 does not detect these wireless communication signals, the current radio capability 412 indicates that the UE 110 does not have network coverage at the position 400. This can occur if the physical location of the UE 110 is indoors, such as at the interior location 310 within the building of FIG. 3, and the RAT operates in a high (or ultra-high) frequency band. Additionally or alternatively, this can occur if the orientation causes the UE 110 to experience additional losses for the high (or ultra-high) frequency band.

Alternatively, if the signal strength is sufficient for wireless communication with the base station 120, the current radio capability 412 indicates that the UE 110 has network coverage at the position 400. This can occur if the UE 110 is on the roof of the building at the location 308, if the UE 110 is at the outdoor location 324 that is not blocked by trees during a fall or winter season, or if the UE 110 is at the location 330 while the weather is sunny, as shown in FIG. 3, and the RAT operates in the high (or ultra-high) frequency band. Additionally or alternatively, this can occur if the orientation facilitates operation at the high (or ultra-high) frequency band. In other cases, the capability module 216 determines the current radio capability 412 based on coverage data provided by the coverage map manager 164, as further described with respect to FIG. 5.

At 415, the capability module 216 modifies the UE 110's radio capability from the previous radio capability at the previous position to the current radio capability 412 at the current position 400. A difference between the previous radio capability and the current radio capability can be caused by the UE 110 moving from the previous position that did not have network coverage to the current position that has network coverage, or vice versa. In some cases, the RAT or frequency band associated with the network coverage provides a higher data rate, greater capacity, improved reliability, or a lower latency relative to other RATs or other frequency bands that are available at the current position 400. With dynamic capability reporting based on position, the UE 110 can transition between realizing improved wireless communication performance using the RAT and frequency band and conserving resources, such as power, as the UE 110 moves between positions for which network coverage varies.

At 420, the capability module 216 informs the RAN 140 of this radio-capability modification responsive to modifying the UE 110's radio capability. In particular, the UE 110 sends a capability report message 422 to the base station 120, which informs the RAN 140 of the modification to the UE 110's radio capability. Example types of capability report messages 422 include a tracking area update (TAU) message 424, a radio-link failure message 426, a reconfiguration failure message 428, or an attach-procedure message 430. By sending the capability report message 422, the UE 110 can prevent the base station 120 from causing the UE 110 to perform additional measurement procedures associated with a RAT and/or frequency band for which the UE 110 does not have network coverage for at the current position 400. If the UE 110 does not have radio capability, the UE 110 can use a different RAT and/or a different frequency band for which network coverage exists at the position 400 to send the capability report message 422.

Generally, the tracking area update message 424 includes an information element that indicates whether or not the UE 110 has radio capability for a particular RAT. Optionally, one or more frequency bands may be included as a radio capability parameter. The capability module 216 modifies this information element to correspond with the current radio capability 412 determined at element 410. In this way, the tracking area update message 424 can be used to directly inform the RAN 140 of the current radio capability 412 and effectively indicate whether the UE 110 has network coverage or does not have network coverage at the position 400. In contrast to current triggers that send a tracking area update message if a TA of the UE 110 changes, for instance, multiple tracking area update messages 424 are sent in this situation as the UE 110 determines that the network coverage changes as it moves to different positions (e.g., locations and/or orientations) within a same TA.

If the previous position had network coverage and the current position 400 does not have network coverage, the capability module 216 can trigger a radio-link failure procedure or a reconfiguration failure procedure. These procedures can respectively cause the UE 110 to send the radio-link failure message 426 or the reconfiguration failure message 428. Either of these messages direct the RAN 140 to delete or otherwise modify stored radio capability information of the UE 110, which includes the previous radio capability. This indirectly informs the RAN 140 of the UE 110's current radio capability 412 and effectively indicates that the UE 110 does not have network coverage at the current position.

Alternatively, the UE 110 sends the attach-procedure message 430 to the base station 120 during an attach procedure. Similar to the tracking area update message 424, the attach-procedure message 430 includes a radio capability information element to directly inform the RAN 140 of the current radio capability 412 of the UE 110.

At 435, the UE 110 manages its resources according to the radio capability 412. If the radio capability 412 indicates the UE 110 does not have network coverage for a particular RAT or a given frequency band, the UE 110 disables operations or transceiver components associated with the RAT or the frequency band to conserve timing resources and battery life. Alternatively, if the radio capability 412 indicates the UE 110 has network coverage for the RAT or the frequency band, the UE 110 enables these operations and transceiver components to utilize resources for the RAT or the frequency band.

FIG. 5 illustrates details of example control transactions between devices for dynamic capability reporting based on position. During these transactions, the UE 110 is considered to be at a current position 500, which can be a particular location or orientation. The location can be inside of a building, along a pedestrian walkway, on a remote hiking trail, at various altitudes either indoors or outdoors, and so forth. The orientation can result in a side of the UE 110 facing North, South, West, East, up (e.g., away from a center of the Earth), down (e.g., towards the center of the Earth), and so forth. At 505, the capability module 216 of the UE 110 determines the UE 110's current radio capability 506 at the position 500 using the measurement procedure described above in FIG. 4.

At 510, the capability module 216 sends a position-specific capability feedback message 512 to the coverage map manager 164 using one or more base stations 120. The position-specific capability feedback message 512 includes the radio capability 506 and the position 500 of the UE 110 that is associated with the radio capability 506 (e.g., the position 500 is the location and/or orientation at which the measurement procedure was performed to determine the radio capability 506). The position 500 is a multi-dimensional position provided by the position sensor 218, as described above. In some cases, the position-specific capability feedback message 512 is an upper layer or an over-the-top message. If the UE 110 does not have network coverage for a preferred RAT or frequency band, the UE 110 may use a different RAT or a different frequency band for which it has network coverage at the position 400 to send the position-specific capability feedback message 512.

The position-specific capability feedback message 512 can also include other information such as the TA or the RAN notification area associated with the position 500, the RAT and frequency band associated with the radio capability 506, a frequency bandwidth, or PCI information of a serving base station 120. Other information that characterizes conditions affecting the radio capability 506 can also be included within the position-specific capability feedback message 512. As an example, this information includes a date and time the radio capability 506 was determined, the current weather, measurements used to determine the radio capability 506 (e.g., a measured signal strength), or information collected using other sensors of the UE 110 that indicate a quality or accuracy of the position 500 or indicate whether the UE 110 is indoors or outdoors or even in a tunnel.

At 515, the coverage map manager 164 updates a coverage map 516. As described above, the coverage map 516 is a multi-dimensional map that indicates a likelihood of network coverage existing at different positions for different RATs and different frequency bands. Due to a resolution of the position 500, the different positions represented by the coverage map 516 can include multiple positions or micro-environments within a TA or a RAN notification area. A portion of the coverage map 516 is shown at 518, with each block representing a particular position or range of positions in latitude, longitude, and altitude. A shading of a block represents a likelihood of network coverage (for a particular RAT and frequency band) existing at the position. A lighter shade (e.g., white) indicates that coverage is likely while a darker shade (e.g., black) indicates that coverage is unlikely. The coverage map manager 164 updates the coverage map 516 by modifying the coverage data associated with the position 500 as received from multiple UE capability report or feedback messages over time (e.g., by increasing or decreasing the coverage likelihood according to the received radio capability 506).

As the UE 110 moves to a second position, the UE 110 determines a second radio capability at the second position and sends a second position-specific capability feedback message 512 using one or more base stations 120 to the coverage map manager 164 with the second radio capability and the second position. Over time, the UE 110 can return to the position 400 or other UEs 110 can move to the position 500. These UEs 110 send other position-specific capability feedback messages 512 to the coverage map manager 164 to improve an accuracy of the coverage data at the position 500. As environmental changes occur, however, the radio capability reported by these UEs 110 for the position 500 changes. As such, the coverage map manager 164 can update a position within the coverage map 516 that previously was unlikely to have network coverage to indicate that network coverage is likely or update another position that previously was likely to have network coverage to indicate that network coverage is unlikely.

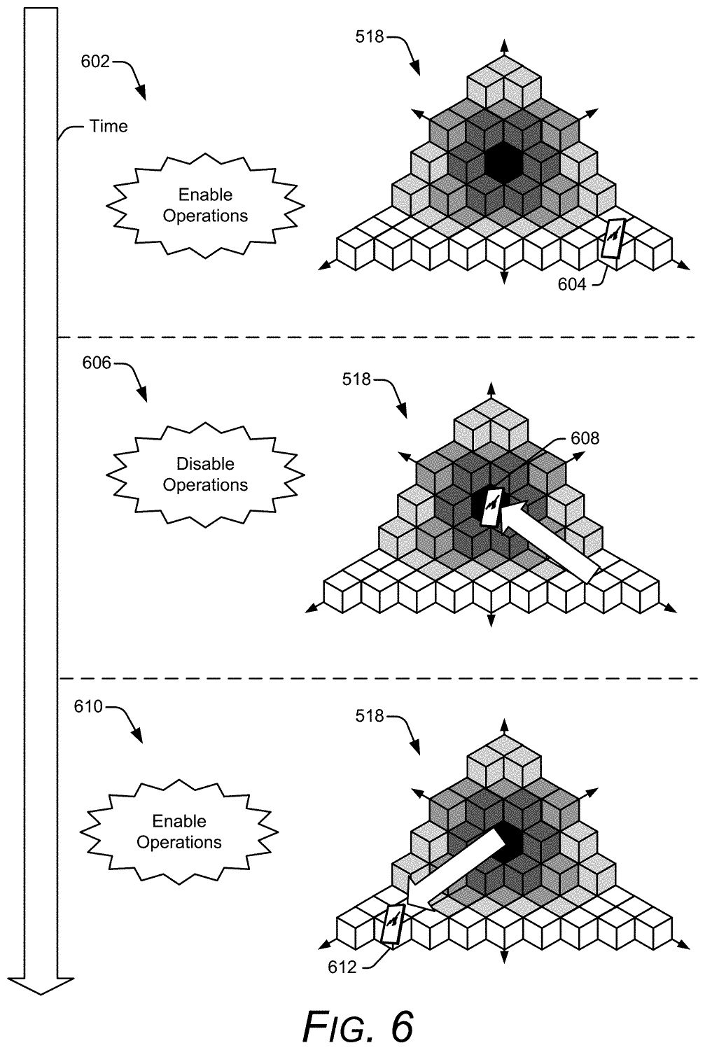

For positions within an ellipse 520, the coverage map manager 164 received one or more position-specific capability feedback messages 512 that indicate one or more UEs 110 did not have network coverage. For positions within an ellipse 522, the coverage map manager 164 received one or more capability report messages 422 from one or more UEs 110 had coverage. This coverage data can be used to inform other UEs 110 of a likelihood that network coverage exists at various positions, as further described in FIG. 6.

With the information provided by position-specific capability feedback messages 512, the coverage map manager 164 can organically learn about the current network coverage and dynamically update the coverage map 516 to reflect the current network coverage. Initially, the coverage map 516 changes dramatically as the coverage map manager 164 receives position-specific capability feedback messages 512. As a quantity of received position-specific capability feedback messages 512 increases, however, the coverage map 516 can become generally stable, e.g., without dramatic changes. Although the coverage map 516 can become stable, the coverage map manager 164 continues to receive position-specific capability feedback messages 512 to update the coverage map 516 for changes that affect the network coverage, such as those described above with respect to FIG. 3. In some aspects, the coverage map manager 164 uses machine learning to responsively update the coverage map 516 for repeatable coverage changes, such as those resulting from changes associated with the time of day, seasonal changes, or weather changes. In some cases, the coverage map manager 164 maintains multiple versions of the coverage map 516 that are associated with different dates, times, or weather. The coverage map manager 164 can also use machine learning to detect and responsively update the coverage map 516 for semi-permanent coverage changes, such as those resulting from construction of new buildings or from the addition of new base stations 120.

At 525, the coverage map manager 164 sends a coverage map message 526 to the UE 110. The coverage map manager 164 can send the coverage map message 526 to the UE 110 in response to receiving a request from the UE 110 (not shown) or on a periodic or non-periodic basis. The coverage map message 526 includes coverage data 528 associated with at least a portion of the coverage map 516. In some cases, the UE 110 can provide the coverage map manager 164 its current position (e.g., the position 500, the TA, or the RAN notification area) to direct the coverage map manager 164 to include coverage data 528 associated with the position. This can reduce a size of the coverage data 528 that is included within the coverage map message 526. The coverage map manager 164 sends the coverage map message 526 to the UE 110 using an upper layer message, such as a non-access stratum (NAS) message. Similar to the capability report message 422 of FIG. 4, the coverage map manager 164 can send the coverage map message 526 using any RAT and any frequency band for which the UE 110 has network coverage at the position 500.

At 530, the UE 110 determines a map-based radio capability 532 at the position 500 based on the coverage data 528. In particular, the UE 110 identifies the portion of the coverage map 516 provided using the coverage data 528 that corresponds to the position 500 and determines the map-based radio capability 532 based on whether the coverage data 528 indicates that coverage is likely or unlikely at the position 500.

In some cases, the UE 110 compares the coverage data 528 to a threshold. If the likelihood of network coverage is greater than the threshold (e.g., greater than approximately 50% or 75%), the map-based radio capability 532 indicates the UE 110 has network coverage at the position 500. However, if the likelihood of network coverage is less than the threshold (e.g., less than approximately 50% or 75%), the map-based radio capability 532 indicates that the UE 110 does not have network coverage at the position 500. In some aspects, the UE 110 dynamically adjusts the threshold based on current available resources of the UE 110. For example, if the UE 110 is low on battery, the UE 110 increases the threshold to 90% so that the UE 110 is less likely to determine it has radio capability except for positions that have a high probability of network coverage. This can enable the UE 110 to conserve power until the battery is recharged.

The UE 110 can use the coverage data 528 to determine the radio capability 412 of FIG. 4 without performing a measurement procedure at element 410. As such, the UE 110 can further save system resources by relying on the coverage data 528 and using the map-based radio capability 532 as the radio capability 412. Alternatively, the UE 110 can use both the coverage data 528 and measurement procedures to determine the radio capability 412 at the position 400. In some aspects, the UE 110 informs a user regarding whether or not it has network coverage at the current position 400. If the UE 110 does not have network coverage, the UE 110 can inform the user of other nearby positions that are likely to have network coverage based on the coverage data 528. This can cause the user to move to a different position that has network coverage for the RAT and enable the UE 110 to utilize the RAT to facilitate wireless communications.

In some situations, the radio capability 412 and the radio capability 506 are a same radio capability of the UE 110. This can occur if the radio capability 412 and the radio capability 506 are determined based on a same measurement procedure, which can occur at element 410 of FIG. 4 or at element 505 of FIG. 5. As such, the same radio capability is communicated to the RAN 140 using the capability report message 422 (e.g., directly or indirectly communicated according to the type of capability report message 422 sent) and is directly communicated to the coverage map manager 164 using the position-specific capability feedback message 512. In other situations, the radio capability 412 determined at element 410 can differ from the radio capability 506 determined at element 505 if the radio capability 412 is determined, at least in part, based on the coverage data 528.

FIG. 6 illustrates an example sequence flow diagram for managing system resources according to the map-based radio capability 532. As the UE 110 moves to different positions, the transactions described above in FIGS. 4 and 5 occur. As such, the UE 110 can continuously control operations according to its radio capability in order to manage system resources.

At 602, the UE 110 is at a position 604. Based on the coverage data 528, the UE 110 determines the map-based radio capability 532 to indicate that the UE 110 has radio capability for one or more RATs at respective sets of frequency bands. Therefore, the UE 110 enables operations associated with a preferred RAT at a preferred frequency band, which causes the UE 110 to use system resources to support wireless communications using the RAT.

At 606, the UE 110 moves from the position 604 that has network coverage to a position 608 that does not have network coverage for that RAT and frequency band. At the position 608, the UE 110 determines it does not have radio capability for the RAT and frequency band based on the coverage data 528. As such, the UE 110 disables operations associated with the RAT or frequency band to conserve system resources while the UE 110 is at the position 608. Note that a different dimension of the coverage map may indicate that alternate RATs or frequency bands are likely to be available, and the UE may attempt to establish a connection using an available alternate radio capability.

At 610, the UE 110 moves from the position 608 that does not have network coverage to a position 612 that has network coverage. At the position 612, the UE 110 determines it again has radio capability for the RAT and frequency band based on the coverage data 528. As such, the UE 110 re-enables operations associated with the RAT.

Example Method

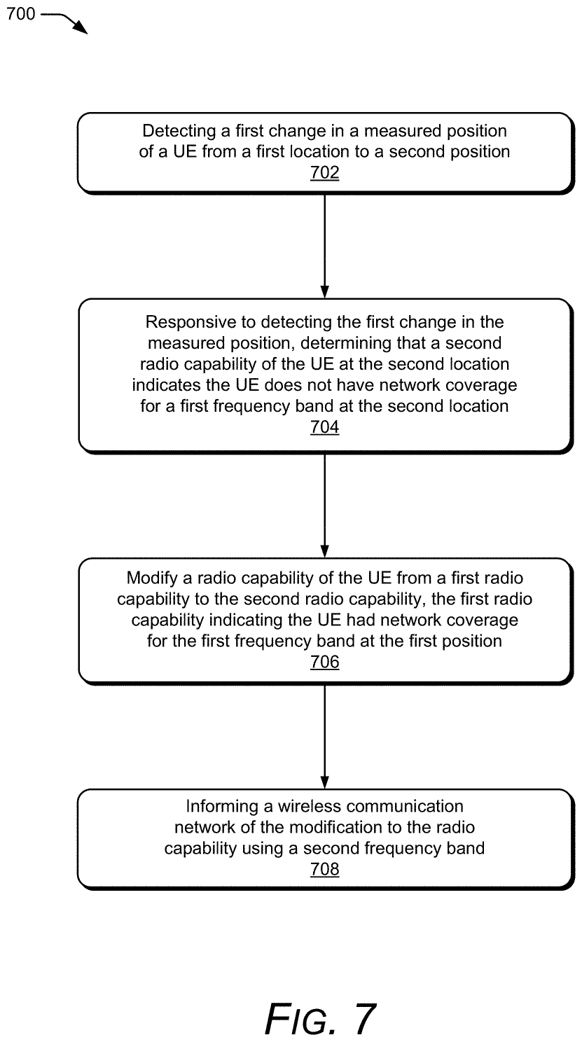

FIG. 7 depicts an example method 700 for dynamic capability reporting based on position. Method 700 shows a set of operations (or acts) performed but not necessarily limited to the order or combinations in which the operations are illustrated. Further, any of one or more of the operations can be repeated, combined, reorganized, linked, or skipped to provide a wide array of additional and/or alternative methods. In portions of the following discussion, reference can be made to environment 100 of FIG. 1 or 302, 306, 312, 318, 322, 326, 328, or 332 of FIG. 3 and entities detailed in FIGS. 2, 4, and 5, reference to which is made for example only. The techniques are not limited to performance by one entity or multiple entities operating on one device.

At 702, a UE detects a first change in its measured position from a first position to a second position. For example, the capability module 216 detects a change in a measured position of the UE 110 from a first position to a second position. In some cases, the position sensor 218 is a GNSS or a GPS sensor that determines multi-dimensional positions of the UE 110 according to a given coordinate system. As an example, a multi-dimensional position can include a latitude, a longitude, and an altitude of the UE 110. The position sensor 218 can also include a gyroscope, which determines an orientation of the UE 110, such as a roll, a yaw, and a pitch. The pitch, roll, and yaw can be added to latitude, longitude, and altitude to produce a position that specifies up to six degrees of freedom. In some cases, an accuracy of the measured position is improved by using measurements from other types of sensors, such as inertial sensors.

At 704, responsive to detecting the first change in the measured position, the UE determines its radio capability at the second position does not include network coverage for a first frequency band. For example, the capability module 216 determines the current radio capability 412 of the UE 110 at the current position 400 using a measurement procedure (as described in element 410 of FIG. 4), using the coverage data 528 provided by a previously-received coverage map message 526 (of FIG. 5), or a combination thereof. In this example, the current radio capability 412 indicates that the UE 110 does not have network coverage for a first frequency band, such as a mmWave frequency band, which can correspond to one or more RATs. This can occur if the UE 110 is at the location 304 that is blocked by a building (shown at 306 in FIG. 3), a location 310 that is inside of the building (shown at 306 in FIG. 3), a location 314 that is far away from a nearest base station 120 (shown at 312 in FIG. 3), a location 324 that is blocked by trees (shown at 326 in FIG. 3), a location 330 with rainy weather (shown at 332 in FIG. 3), or at an orientation that experiences higher polarization mismatch loss or propagation loss relative to another orientation, for example.

At 706, a radio capability of the UE is modified from a first radio capability to the second radio capability. The first radio capability indicates the UE had coverage for the first frequency band at the first position. For example, the capability module 216 modifies a radio capability of the UE 110 from a previous radio capability to the current radio capability 412. The previous radio capability indicates the UE 110 had coverage for the first frequency band at the previous position using one or more RATs. As an example, the previous position can be at the outdoor location 304 that is not blocked by a building (shown at 302 in FIG. 3), outside the building on a balcony or on a rooftop (shown at 306 in FIG. 3), at a location 314 near the base station 320 (shown at 318 in FIG. 3), at a location 324 that is not blocked by trees (shown at 322 in FIG. 3), or in a sunny location 330 (shown at 328 in FIG. 3).

At 708, the UE informs a wireless communication network of the modification to the radio capability using a second frequency band. For example, the capability module 216 uses a sub-6 GHz frequency band to inform the RAN 140 of the modification to the radio capability of the UE 110. In particular, the capability module 216 sends, to the base station 120, the capability report message 422 to directly, or indirectly, inform the wireless communication of the second radio capability. The capability report message 422 can be the tracking area update message 424, the radio-link failure message 426, the reconfiguration failure message 428, or the attach-procedure message 430 of FIG. 4.

Alternatively or additionally, the UE detects a second change in the measured position of the UE from the second position to a third position. Responsive to detecting the second change, the UE determines that a third radio capability of the UE 110 indicates that the UE 110 has network coverage for the first frequency band at the third position. In this case, the capability module 216 modifies the radio capability of the UE from the second radio capability to the third radio capability, and informs the wireless communication network of the modification to the radio capability. In particular, the capability module 216 can send the tracking area update message 424 or the attach-procedure message 430. The UE 110 can also enable wireless communication operations or assign resources to the first frequency band to improve wireless communication performance.

### CONCLUSION

Although techniques for dynamic capability reporting based on position have been described in language specific to features and/or methods, it is to be understood that the subject of the appended claims is not necessarily limited to the specific features or methods described. Rather, the specific features and methods are disclosed as example implementations of dynamic capability reporting based on position.

Some examples are described below.

Example 1: A user equipment (UE) including:

a position sensor configured to determine a previous position of the UE and a current position of the UE; and

a capability module coupled to the position sensor, the capability module configured to:
detect a change in a position of the UE from the previous position to the current position;
responsive to detecting the change in the position, determine a current radio capability of the UE at the current position; and
responsive to the current radio capability being different than a previous radio capability at the previous position, inform a wireless communication network of the current radio capability.

Example 2: The UE of example 1, wherein the capability module is further configured to:

receive a coverage map message from a coverage map manager of the wireless communication network, the coverage map message including coverage data associated with the current position, the coverage data indicating a likelihood of network coverage at the current position; and

determine the current radio capability of the UE based on the coverage data.

Example 3: The UE of example 1, wherein the capability module is further configured to:

modify a radio capability of the UE from the previous radio capability to the current radio capability; and

modify wireless communication operations of the UE based on the modification to the radio capability of the UE.

Example 4: The UE of example 1, wherein the capability module is further configured to:

perform a measurement procedure to determine the current radio capability; and

send a position-specific capability feedback message to a coverage map manager of the wireless communication network, the position-specific capability feedback message including the current position and the current radio capability.

Example 5: The UE of example 1, wherein:

the previous position has network coverage for a first radio access technology (RAT) within a first frequency band; and

the current position does not have network coverage for the first RAT within the first frequency band.

Example 6: The UE of example 5, wherein:

the capability module is further configured to:
inform the wireless communication network of the current radio capability using a second frequency band; and

the second frequency band is associated with the first RAT or a second RAT.

Example 7: The UE of example 6, wherein:

the first frequency band includes frequencies greater than approximately 24 gigahertz (GHz); and

the second frequency band includes frequencies less than approximately 24 GHz.

Example 8: The UE of example 1, wherein the previous position and the current position are within a same tracking area (TA) or a same Radio Access Network (RAN) notification area of the wireless communication network.

Example 9: The UE of example 1, wherein the capability module is further configured to:

send a tracking area update (TAU) message to the wireless communication network to inform the wireless communication network of the current radio capability.

Example 10: The UE of example 1, wherein the position sensor includes a global navigation satellite system (GNSS) sensor.

Example 11: The UE of example 10, wherein the global navigation satellite system (GNSS) position sensor is a global positioning system (GPS) sensor.

Example 12: The UE of example 1, wherein the position sensor includes at least one of the following:

a Bluetooth™ receiver;

a WiFi™ receiver;

a radar;

a gyroscope;

an accelerometer; or

an inertial sensor.

Example 13: The UE of example 1, wherein the change in the position of the UE comprises at least one of the following:

a change in longitude;

a change in latitude;

a change in altitude;

a change in pitch;

a change in roll; or

a change in yaw.

Example 14: The UE of example 1, wherein the position sensor includes an image processing sensor configured to:

determine that the previous position and the current position each correspond to one of the following:
a location that is inside a building;
a location that is outside; or
a location that is inside a tunnel.

Example 15: A method for a user equipment (UE) comprising:

detecting a first change in a measured position of the UE from a first position to a second position;

responsive to detecting the first change in the measured position, determining that a second radio capability of the UE at the second position indicates the UE does not have network coverage for a first frequency band at the second position;

modifying a radio capability of the UE from a first radio capability to the second radio capability, the first radio capability indicating the UE had network coverage for the first frequency band at the first position; and

informing a wireless communication network of the modification to the radio capability using a second frequency band.

Example 16: The method of example 15, wherein:

the first change in the measured position comprises a translation in space from the first position to the second position; and

the first position and the second position are within a same tracking area (TA) of the wireless communication network.

Example 17: The method of example 16, wherein the first change in the measured position further comprises a rotation in space from the first position to the second position.

Example 18: The method of example 15, further comprising:

detecting a second change in the measured position of the UE from the second measured position to a third measured position;

responsive to detecting the second change in the measured position, determining that a third radio capability of the UE at the third position indicates the UE has network coverage for the first frequency band at the third position;

modifying the radio capability of the UE from the second radio capability to the third radio capability; and

informing the wireless communication network of the modification to the radio capability.

Example 19: The method of example 18, further comprising:

receiving a coverage map message from a coverage map manager of the wireless communication network, the coverage map message including coverage data that indicates likelihoods of the UE having network coverage at the second position and the third position for the first frequency band; and

determining the second radio capability and the third radio capability based on the coverage data.

Example 20: The method of example 15, wherein informing the wireless communication network of the modification to the radio capability further comprises one of the following:

sending a tracking area update (TAU) message to the wireless communication network;

triggering a radio-link failure procedure and sending a radio-link failure message to the wireless communication network as part of the radio-link failure procedure;

triggering a reconfiguration failure procedure and sending a reconfiguration failure message to the wireless communication network as part of the reconfiguration failure procedure; or

sending an attach-procedure message to the wireless communication network during an attach procedure.

1. A method for a user equipment comprising:
operating with a first radio capability at a first position;
detecting a first change in a measured position of the user equipment from the first position to a second position;
receiving a coverage map message from a coverage map manager of a wireless communication network, the coverage map message including coverage data associated with the second position, the coverage data indicating a likelihood in a range of likelihoods of network coverage at the second position, the likelihood representing a probability that is greater than 0% and less than 100%;
determining a second radio capability of the user equipment based on the coverage data; and
responsive to the second radio capability being different than the first radio capability, informing the wireless communication network of the second radio capability.

2. The method of claim 1, wherein:
the first radio capability indicates the user equipment has network coverage for a first frequency band at the first position; and
the second radio capability indicates the user equipment does not have network coverage for the first frequency band at the second position.

3. The method of claim 0, wherein the informing the wireless communication network comprises informing the wireless communication network of the second radio capability using a second frequency band.

4. The method of claim 3, wherein:
the first frequency band is associated with a first radio access technology; and
the second frequency band is associated with a second radio access technology.

5. The method of claim 3, wherein:
the first frequency band includes frequencies greater than approximately 24 gigahertz; and
the second frequency band includes frequencies less than approximately 24 gigahertz.

6. The method of claim 1, wherein:
the coverage map message includes coverage data associated with a third position, the coverage data indicating a second likelihood in the range of likelihoods of network coverage at the third position,
the method further comprising:
detecting a second change in the measured position of the user equipment from the second position to the third position;
determining a third radio capability of the user equipment based on the coverage data; and
responsive to the third radio capability being different than the second radio capability, informing the wireless communication network of the third radio capability.

7. The method of claim 6, wherein the third radio capability indicates the user equipment has network coverage for a third frequency band at the third position.

8. The method of claim 1, wherein informing the wireless communication network comprises sending a tracking area update message to the wireless communication network.

9. The method of claim 1, wherein informing the wireless communication network comprises:
triggering a radio-link failure procedure; and
sending a radio-link failure message to the wireless communication network as part of the radio-link failure procedure.

10. The method of claim 1, wherein informing the wireless communication network comprises:
triggering a reconfiguration failure procedure; and
sending a reconfiguration failure message to the wireless communication network as part of the reconfiguration failure procedure.

11. The method of claim 1, wherein informing the wireless communication network comprises sending an attach-procedure message to the wireless communication network during an attach procedure.

12. The method of claim 1, wherein:
the first change in the measured position comprises a translation in space from the first position to the second position; and
the first position and the second position are within a same tracking area or Radio Access Network notification area of the wireless communication network.

13. The method of claim 1, wherein the first change in the measured position comprises a rotation in space from the first position to the second position.

14. (canceled)

15. A user equipment comprising:
a radio-frequency transceiver; and
a processor and memory system configured to:
operate with a first radio capability at a first position;
detect a first change in a measured position of the user equipment from the first position to a second position;
receive, using the radio-frequency transceiver, a coverage map message from a coverage map manager of a wireless communication network, the coverage map message including coverage data associated with the second position, the coverage data indicating a likelihood in a range of likelihoods of network coverage at the second position, the likelihood representing a probability that is greater than 0% and less than 100%;
determine a second radio capability of the user equipment based on the coverage data; and
responsive to the second radio capability being different than the first radio capability, informing the wireless communication network of the second radio capability.

16. The user equipment of claim 15, wherein the processor and memory system are further configured to:
compare the likelihood of network coverage at the second position to a threshold; and
operate with the second radio capability responsive to the likelihood of network coverage being greater than the threshold.

17. The user equipment of claim 15, wherein the processor and memory system are further configured to:
dynamically adjust the threshold based on available resources of the user equipment.

18. The method of claim 1, wherein the detecting the first change in the measured position of the user equipment comprises at least one of the following:
detecting a change to a physical location of the user equipment; or
detecting a change to an orientation of the user equipment.

19. The method of claim 1, wherein the determining the second radio capability comprises:
comparing the likelihood of network coverage at the second position to a threshold; and
operating with the second radio capability responsive to the likelihood of network coverage being greater than the threshold.

20. The method of claim 19, further comprising:
dynamically adjusting the threshold based on available resources of the user equipment.

21. The method of claim 20, further comprising:
increasing the threshold responsive to available power stored within a battery of the user equipment decreasing.
